(19) United States
(12) Patent Application Publication
(10) Pub. No.: US 2015/0311734 A1
(43) Pub. Date: Oct. 29, 2015

(54) Dynamic Chargers Network and the Method of Producing the Same

(71) Applicants: Michael Kadie, San Diego, CA (US); Kenneth Wing, Alpine, CA (US); Craig Miller, San Clemente, CA (US)

(72) Inventors: Michael Kadie, San Diego, CA (US); Kenneth Wing, Alpine, CA (US); Craig Miller, San Clemente, CA (US)

(21) Appl. No.: 14/264,484

(22) Filed: Apr. 29, 2014

(51) Int. Cl. H02J 7/00

(52) U.S. Cl. CPC H02J 7/0052; H02J 7/007; H02J 7/0068

(57) ABSTRACT

The present invention relates generally to a battery charger network for large capacity batteries and the method of dynamically engaging and disengaging any one charger to a power bus charging the battery.

### CROSS-REFERENCE TO RELATED APPLICATIONS

This application claims the benefit under 35 U.S.C. §153(b) of U.S. patent application Ser. No. 13/336,031, entitled Method of Establishing a Battery Charging Network filed on Jan. 23, 2012, the contents of the aforementioned application is hereby incorporated by reference in its entirety.

### TECHNICAL FIELD

The present invention relates generally to a battery charger network for large capacity batteries and the method of dynamically engaging and disengaging any one charger to a power bus charging the battery.

### BACKGROUND

A high voltage battery system, such as battery pack which is a composition of individual cells, is a critical element of several important applications such as electric vehicle drives and mass energy storage systems. A “cell” can mean a single electrochemical cell comprised of the most basic units, i.e. a positive plate, a negative plate, and an electrolyte. However, as used herein, the term is not so limited and may include a group of cells that can comprise a single unit as a component of a battery pack and the use of the latest in battery chemistries, i.e. lithium and lithium combinations. A battery or battery pack is a series or parallel connection of units or individual cells.

Achieving wide market acceptance for high voltage battery applications requites an economically viable system for charging high voltage battery packs. Addressing this demand requires developing a high power density charging system that can supply a controlled charging current at high output voltages. However, realizing such a system requires overcoming certain practical problems related to the high output voltage.

In principle, a battery charger is a power supply with controllable voltage, current and power limits. What differentiates a battery charger from a conventional power supply is the capability to satisfy the unique requirements of a battery pack. Typically, battery chargers have two tasks to accomplish. The first, and most important, is to restore capacity as quickly as possible and the second is to maintain capacity by compensating for self-discharge and ambient temperature variations. These tasks are normally accomplished by controlling the output voltage, current and power of the charger in a preset manner, namely, using a charging algorithm.

There are two types of chargers m the market today. One such type is known as a smart charger and has the ability to communicate logically with the batteries or a battery management system and has the ability to scale its power based on the charge required. The other is a simply charger and is either turned on where its supplying is predesigned power or it is turned off and not supplying its predesigned power and does not have a means of logically communicating with the battery management system.

As taught in the referenced Kaddie et al., is the ability to communicate and have two chargers wherein one is a master and the other is a slave. Although this is a great benefit in adding more power and quicker recharge times it still limited to haying just two chargers. Additionally, as more chargers were added the charging system as taught in Kaddie et al. would have to be turned off and then turned back on again.

Therefore it is desirable to have a charger that is enabled to increase its ability to provide more power or throttle up power to meet the charging requirements of the battery pack such that the charging of the battery string can happen more quickly. Additionally, it would also be advantageous to have a charger that can decrease power or throttle down, such that overcharging doesn't occur which can critically damage a battery.

### SUMMARY

While the apparatus and method has or will he described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The present invention specifically addresses and alleviates the above mentioned deficiencies associated with the prior art. According to a preferred aspect of the present invention the method of dynamically adding or removing a charger enables additional power when needed while also enabling the removal of a charger when additional power is now required.

### BRIEF DESCRIPTION OF THE DRAWINGS

FIG. 1 represents an embodiment of the present invention where more than one charger is needed.

FIG. 2 illustrates the process relating to powering on the charger network of the present invention.

FIG. 3 represents a flowchart of the method of the present invention.

FIG. 4 illustrates an electrical design of the physical connections between the chargers, battery management systems and buses.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

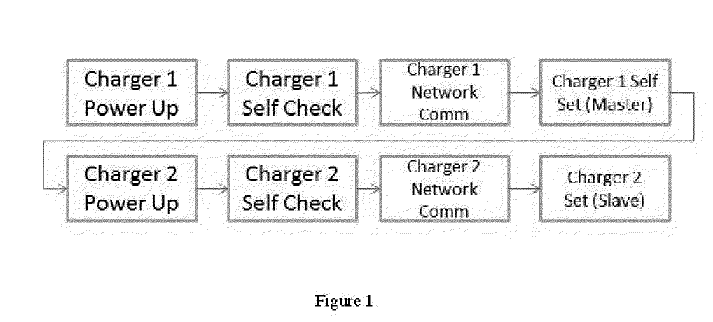

FIG. 1 represents another embodiment of the present invention where more than one charger is needed and the chargers are dynamically added and removed from supplying power to the power bus which powers the load based on a comparison process. In the most preferred embodiment the comparison process is performed by a master charger that has established a logical network through a physical communication channel with another charger and a battery management system. Once the network is established, additional charger's battery management systems may be added to the network.

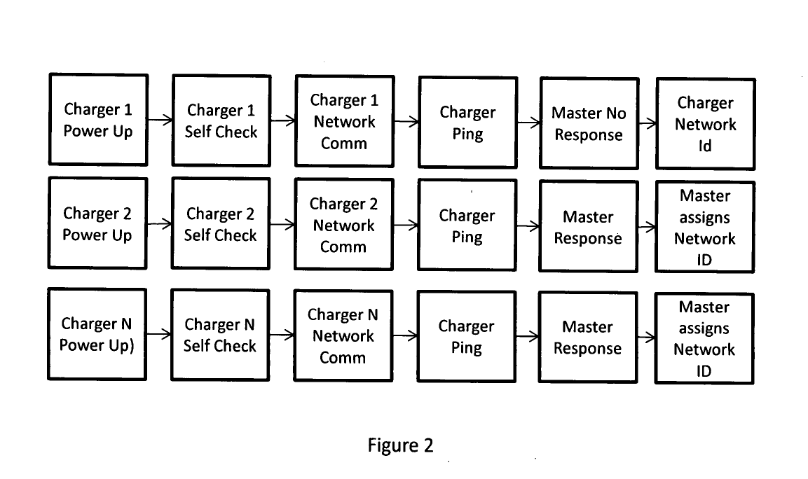

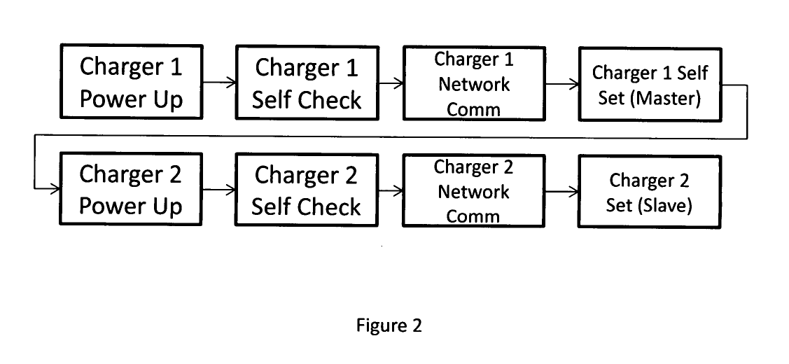

Three chargers as represented in FIG. 2 better explain the process wherein all the chargers are powered on. As shown in FIG. 2 one charger is the master-charger. Once one charger is the defined as the master, the master charger establishes the network of chargers by sending a signal through the physically connected communication channel of any other chargers which are logically enabled to receive such signal and logically begin communicating. As a part of the setup process of the physical and logical connection infrastructure, at least one power bus is provided to each charger such that the charger is enabled through switches and relays to provide the charger's power to the power bus. In the present embodiment of the invention the power bus is connected to a battery to enable the recharging of the battery. Additionally, each power bus is provided with an identification number which is logically stored within the charger such that the charger is aware of the exact power bus available and the number of power buses available to provide power. As a part of the method, the master charger verifies the chargers available for a specific power bus and assigns a logical charger identification number to the charger for use.

Once the master charger has identified all the available chargers and the available buses the master charger listens for broadcasting performed on the physical communication network whereby the master charger is able to understand such broadcast from a battery management system. Once information on the broadcast is received from a battery management system, the basic information about the battery load required by the battery to recharge the battery is provided to the master charger. This information consists of: the voltage required, the maximum amperage the battery can take at any one time, and the overall power rating of the battery. Additional information that may be provided by the battery management system includes a maximum heat rating of the battery, the current temperature of the battery and the current state of charge of the battery.

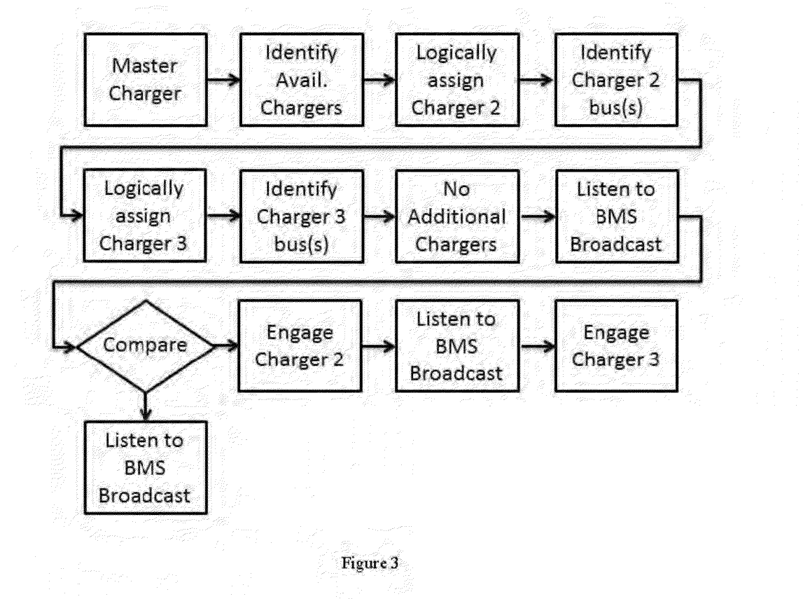

Once the battery management system has communicated the amount of power the battery needs, in the next step of the process, which is represented by FIG. 3 as the compare step, the master charger compares the power requirement with its own output ability and turns on providing the appropriate power output to charge the batteries. If in compare step the master charger cannot provide enough power to meet the power requested by the battery management system, the master charger communicates with the charger that has an identification number of 2 and instructs the charger to provide power to the bus which provides power to the battery and the charger complies. This process is repeated as chargers are added to the bus until the power required by the battery management system is met or when all available chargers are providing power to the bus wherein [master charger+charger ID#n=charger max output] whereby charger ID#n represents each charger available within the network to provide power to a specific, power bus. Once the charging network has reached charger max output the master charger continually monitors communication from the battery management system relating to the voltage and the power the batter needs, compares that requirement with the amount of power provided by the network of chargers powering the bus and in the event that the power the battery needs can be provided with one less charger the master charger communicates to the last charger added to the battery charging network and that is powering the bus to physically stop supplying the power to the bus. This process is repeated until the battery management system has communicated that the battery is fully charged.

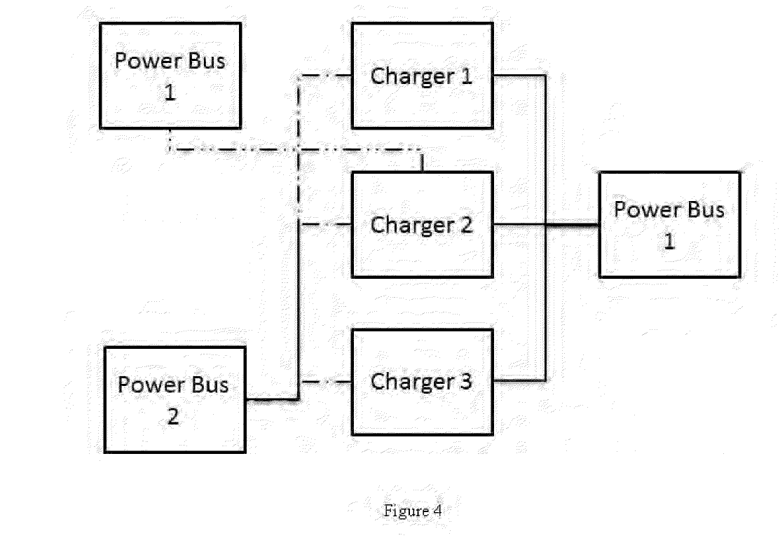

FIG. 4 represents an electrical diagram of the battery charging network and the bus physically connected to the battery. More specifically, charger 1, charger 2, and charger 3 are physically connected to a power bus 1 whereby the electrical connection is designed such that it is enabled to transport large amounts of power, 500 kWs. Additionally, charger 2 is electrically connected to power bus 2 and such electrical connection is also designed such that it is enabled to transport large amounts of power, 500 kW.

As further represented in FIG. 4, charger 1, charger 2, and charger 3 are connected via a separate communication channel. This separate communication channel may also be connected with the battery management system as represented in FIG. 2 but can be on a separate communication channel whereby the battery management system is only connected with the master charger. Additionally, a communication channel may also be connected to a power bus. As the master charger logically receives broadcasts from the battery management system and preforms the compare, the master charger can communicate logically with each individual charger through the physical communication channels thereby instructing an individual charger to engage or disengage with a specific power bus.

It should be understood, of course, that the foregoing relates to exemplary embodiments of the invention and that modifications: may be made with out departing from the spirit and scope of the invention as set forth in the following claims.

Features of the various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the disclosure can be modified, if necessary, with various configurations, and concepts of the various patents, applications, and publications to provide yet further embodiments of the disclosure.

These and other changes can be made to the disclosure in light of the above detailed description. In general, in the folio vying claims, the terms used should not be construed to limit the disclosure to the specific embodiments disclosed in the specification and the claims, but should be construed to include all systems and methods that operate in accordance with the claims. Accordingly, the invention is not limited by the disclosure, but instead its scope is to be determined broadly by the following claims.

What is claimed is:

1. A method of dynamically providing needed power to a battery comprising:
providing a charger network which consists of at least two chargers;
communicating with a battery management system;
providing a bus for the chargers to provide power;
identifying the master charger;
assigning identification numbers to all available chargers; and
engaging or disengaging an available charger to the bus.

2. The method of claim 1, wherein the bus is connected to a battery.

3. The method of claim 1, wherein the charger network is a physical network.

4. The method of claim 1, wherein the charger network is a logical network.

5. A method of comparing and dynamically providing needed power to a battery, comprising:
providing a charger network which consists of at least two chargers;
communicating with a battery management system;
providing a bus for the chargers to provide power;
identifying the master charger;
assigning identification numbers to all available chargers;
receiving information form the battery management system; and
comparing the power needed for the battery and the power available from the charger network;

6. The method of claim 2, wherein the master charger compares the power needed and the available power from the charger network and engages an additional charger with the bus.

7. The method of claim 2, wherein the master charger compares the power needed and the available power from the charger network and disengages an additional charger with the bus.

8. The method of claim 2, wherein the charger network is a physical network.

9. The method of claim 2, wherein the charger network is a logical network.
